(19) United States
(12) Patent Application Publication
(10) Pub. No.: US 2007/0157446 A1
(43) Pub. Date: Jul. 12, 2007

(54) Spring nut insertion tool

(76) Inventor: Werner Kothke, Edmonton (CA)

Correspondence Address: LITMAN LAW OFFICES, LTD., P.O. BOX 15035, CRYSTAL CITY STATION, ARLINGTON, VA, 22215, US

(21) Appl. No.: 11/599,458

(22) Filed: Nov. 15, 2006

Related U.S. Application Data
(60) Provisional application No. 60/756,583, filed on Jan. 6, 2006.

(51) Int. Cl. B25B 27/14

(52) U.S. Cl. 29/278

(57) ABSTRACT

A specialized hand tool utilized for inserting and removing spring nuts from channels and the like. The tool includes a shaft having a coextending, telescoping handle at one end. The other end of the shaft terminates in a nut receiving and holding member configured for entry in a channel to engage a spring nut and secure or remove the same. Magnets, a depending flange and a stud are positioned on the undersurface face of the holding member to enhance engagement to the nut.

### CROSS-REFERENCE TO RELATED APPLICATION

This application claims the benefit of U.S. Provisional Patent Application Ser. No. 60/756,583, filed Jan. 6, 2006.

### BACKGROUND OF THE INVENTION

1. Field of the Invention

The present invention generally relates to hand tools. More specifically, the present invention is drawn to a tool for inserting and removing spring nuts from channels designed to receive the spring nuts.

2. Description of the Related Art

One of the more frustrating aspects of assembling metal structures is inserting (or removing) spring nuts into a channel or the like. This difficult procedure often requires the worker to use his (her) fingers to initiate the insertion or removal process. Thus, the worker must remove work gloves and risk finger cuts or frost bite if the temperature is below freezing. The art would certainly welcome a tool that would alleviate the aforestated problems and create a more efficient technique for inserting and removing spring nuts. Thus an easy-to-use, effective tool solving the aforementioned problems is desired.

The related art is rife with specialized devices for inserting and removing fasteners. Pertinent examples of such related art are cited and identified in the accompanying IDS. However, none of the cited and identified related art discloses a tool for inserting and removing spring nuts as will subsequently be described and claimed in the instant invention.

### SUMMARY OF THE INVENTION

The present invention is drawn to a specialized hand tool utilized for inserting and removing spring nuts from channels and the like. The tool includes a shaft having a coextending, telescoping handle at one end. The other end of the shaft terminates in a nut receiving and holding member configured for entry in a channel to engage a spring nut and secure or remove the same. Magnets, a depending flange and a stud member are positioned on the under surface of the holding member to enhance engagement to the nut.

Accordingly, the invention presents a tool that effectively and efficiently inserts and removes spring nuts from channels and the like. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a spring nut insertion tool according to the present invention.

FIG. 2 is a perspective view of a spring nut insertion tool according to the present invention.

FIG. 3 is a partial, perspective view of a spring nut insertion tool according to the present invention.

Similar reference characters denote corresponding features consistently throughout the attached drawings.

### DETAILED DESCRIPTION OF THE PREFERRED EMBODIMENT

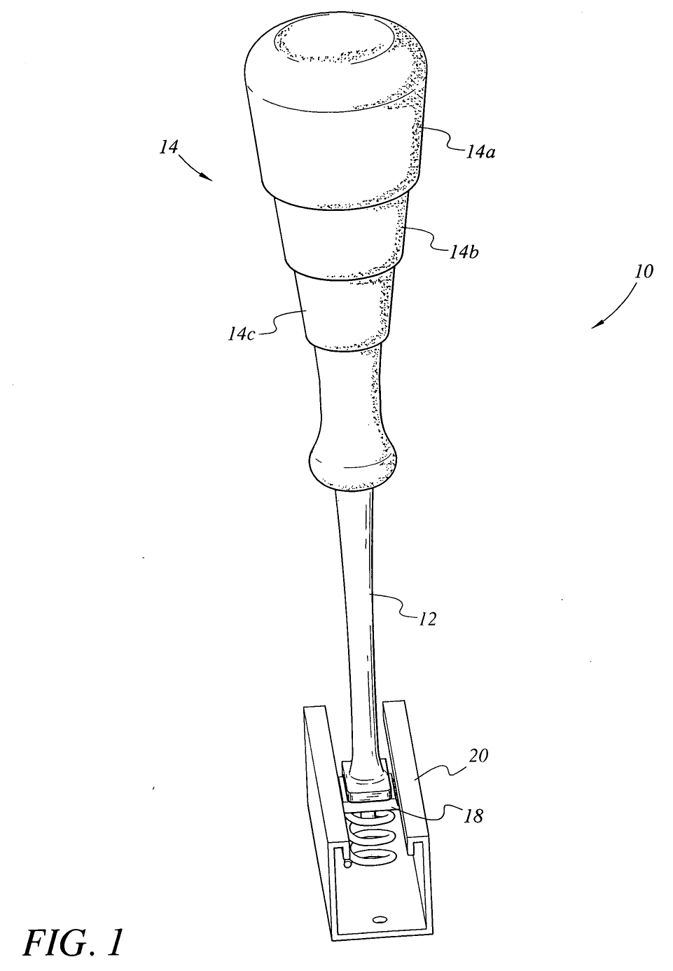

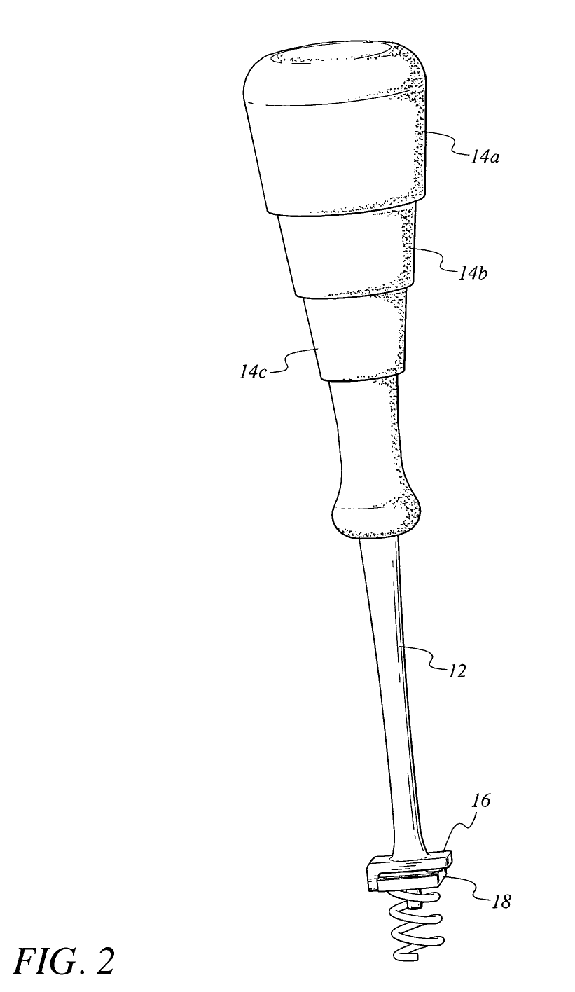

Attention is first directed to FIGS. 1 and 2 of the drawings wherein the tool of the present invention is generally indicated at 10. Tool 10 comprises a shaft 12 having an upper end and a lower end. A handle 14 defines the upper end of shaft 12. Handle 14 may be a single piece grip, or fabricated with telescoping sections 14a, 14b, 14c to allow the handle to be compressed for storage or more effective manipulation. The lower end of shaft 12 terminates in a nut receiving and holding member 16. Member 16 is adapted to engage a spring nut 18, which nut is disposed in a channel 20. Once engaged, the tool can be rotated on its vertical axis to either insert or remove nut 18 from channel 20. The shaft may be integrally formed with the handle 14, or otherwise attached thereto, for example, by inter-engaging screw threads (not shown).

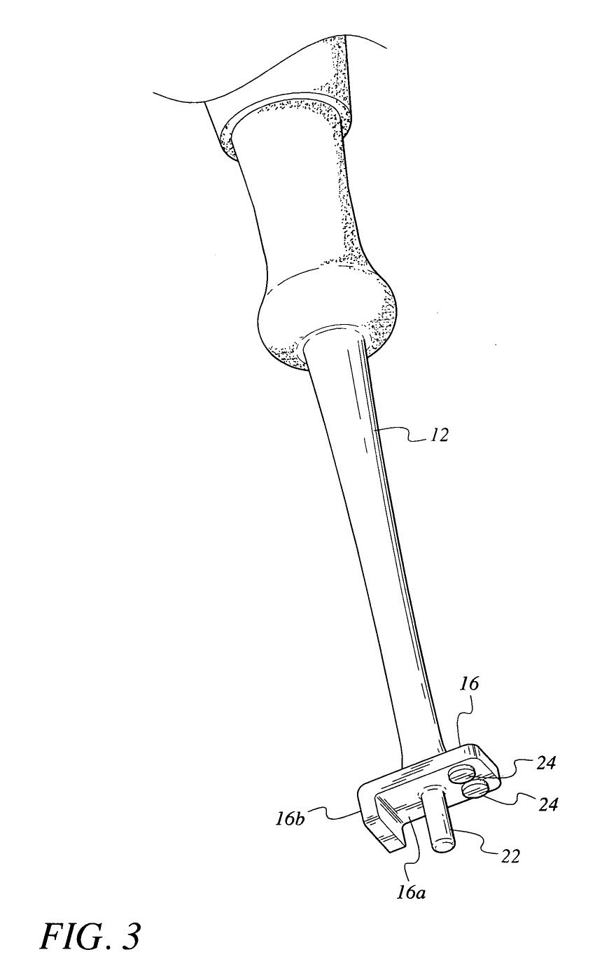

As best seen in FIG. 3, member 16 comprises a flat rectangular base having an under surface 16a. A flange 16b extends downwardly from one edge of the base. A stud 22 extends downwardly from the central area of under surface 16a. Holding magnets 24 are disposed on under surface 16a adjacent the edge of the base opposite flange 16b. The combination of magnets 24, flange 16b and stud 22 functions to secure the nut 18 in place when the nut spring is compressed and the nut is rotated for insertion into the channel.

It is to be understood that the present invention is not limited to the embodiment described above, but encompasses any and all embodiments within the scope of the following claims.

I claim:

1. A spring nut insertion and removal tool, comprising:
a shaft having an upper end and a lower end;
a handle disposed at the upper end of the shaft;
a spring nut engaging and holding member disposed at the lower end of the shaft, the member being of flat, rectangular configuration and having an undersurface and a first edge; and
a flange depending from the first edge.

2. The spring nut insertion and removal tool according to claim 1, wherein said handle comprises telescoping sections.

3. The spring nut insertion and removal tool according to claim 1, wherein said undersurface has a central area and a stud extending from the central area.

4. The spring nut insertion and removal tool according to claim 1, further including a pair of magnets affixed to said undersurface.

5. A spring nut insertion and removal tool, comprising:
a rigid shaft having an upper end and a lower end;
a handle disposed at the upper end of the rigid shaft;
a spring nut engaging and holding member disposed at the lower end of the rigid shaft, the member being of flat, rectangular configuration and having an undersurface, a first edge and a second edge;
a stud extending from the undersurface; and
a flange depending normal to the first edge.

6. The spring nut insertion and removal tool according to claim 5, wherein said handle comprises telescoping sections.

7. The spring nut insertion and removal tool according to claim 5, wherein said undersurface has a central area and wherein said stud extends from the central area.

8. The spring nut insertion and removal tool according to claim 5, further including a pair of magnets affixed to the undersurface adjacent the second edge.

9. A spring nut insertion and removal tool, comprising:
a rigid shaft having an upper end and a lower end;
a handle disposed at the upper end of the rigid shaft, the handle having telescoping sections;
a spring nut engaging and holding member disposed at the lower end of the rigid shaft, the member being of flat, rectangular configuration and having an undersurface, a first edge and a second edge;
a stud extending from the undersurface;
a pair of magnets affixed to the undersurface adjacent the second edge; and
a flange depending normal to the first edge.

10. The spring nut insertion and removal tool according to claim 9, wherein said undersurface has a central area and wherein said stud extends from the central area.
